(19) United States
(12) Patent Application Publication
(10) Pub. No.: US 2011/0284259 A1
(43) Pub. Date: Nov. 24, 2011

(54) ASSEMBLY OF TWISTED INSULATED ELECTRIC WIRES

(76) Inventor: Patrick Odot, Autun (FR)

(21) Appl. No.: 13/133,424

(22) PCT Filed: Dec. 1, 2009
(86) PCT No.: PCT/FR2009/052350

§ 371 Date: Aug. 16, 2011

(30) Foreign Application Priority Data
Dec. 22, 2008 (FR) 0858919

(51) Int. Cl. H01B 11/02; H01B 13/02

(52) U.S. Cl. 174/113 R; 57/296

(57) ABSTRACT

The invention relates to an assembly comprising insulated electric wires arranged in parallel to each other, each electric wire being surrounded by an insulating material and a thermoplastic supporting material, characterised in that the insulated electric wires are twisted together and define a bunch, and in that the thermoplastic supporting material is provided so as to connect all the insulated electric wires of the bunch together so that each insulated electric wire is connected to at least one insulated electric wire adjacent thereto, and so that a portion of the insulation material of at least one insulated electric wire of the bunch remains visually identifiable from outside the assembly.

The present invention relates to an assembly of twisted insulating electrical conductors.

It applies typically, but not exclusively, to the fields of energy cables and/or telecommunication cables and more particularly to low-voltage cables used in buildings, with a maximum voltage of 750 V, in accordance with the European standards H07VU, H07VK, 0771U and 07Z1K.

An assembly of insulated electrical conductors that are easily separable without a special tool suitable for this purpose is known from document FR 2 122 323.

The insulated electrical conductors of this assembly are juxtaposed side by side so as to form a ribbon of insulated electrical conductors. Beads of hot-melt adhesive are placed in the grooves formed between each pair of insulated electrical conductors so as to bond the insulated electrical conductors together. These beads of hot-melt adhesive are interrupted at certain places so as to allow said insulated electrical conductors to be separated and connected.

However, this type of assembly has many drawbacks. Specifically, on the one hand, since the ribbon structure is mainly flexible only in a single direction, it becomes very difficult to insert it into a protective sheath and, on the other hand, since the hot-melt adhesive is very elastic (elongation at break of at least 140%), to separate the insulated electrical conductors where said adhesive is present is not easy.

The object of the present invention is to alleviate the drawbacks of the prior art by providing not only an assembly of insulated electrical conductors that can be easily separated whatever the point of separation along the assembly and without the aid of a specific tool, but also an assembly having very good mechanical retention of all of the insulted electrical, conductors over the entire length of the assembly.

One subject of the present invention is an assembly comprising:
insulated electrical conductors arranged so as to be parallel to one another, each electrical conductor being surrounded by an insulating material; and
a thermoplastic retaining material,
   in which assembly the insulated electrical conductors are twisted together, thus forming a twisted bundle, and said thermoplastic retaining material is placed so as to connect together all the insulated electrical conductors of the twisted bundle so that each insulated electrical conductor is connected to at least one insulated electrical conductor adjacent thereto, and so that a portion of the insulating material of at least one insulated electrical conductor of she twisted bunch remains visually identifiable from outside the assembly.

The types of twisted bunches used for assembling the insulated electrical conductors according to the invention are well known to those skilled in the art and may in particular be formed as a continuous helix or else with an alternating right/left pitch.

The insulated electrical conductors of the twisted bunch are thus retained using the retaining material. Consequently, the twisted bunch of insulated electrical conductors, combined with their mechanical retention along the assembly, makes it possible to obtain an assembly with multi-directional flexibility: the operations of handling the assembly and of inserting it into protective sheaths then prove so be significantly facilitated.

Another advantage lies in the fact that the portion of the insulating material of at least one insulated electrical conductor, typically including a color marking, remains visually identifiable from outside the assembly since the thermoplastic retaining material does not completely cover said insulating material.

In one particular embodiment, the thermoplastic retaining material is chosen from materials having the following physicochemical characteristics:
i) a product P of the density of the thermoplastic retaining material in g/cm³, multiplied by the force in MPa to separate two insulated electrical conductors joined by means of the thermoplastic retaining material, ranging from 1.5 to 3; and
ii) an elongation at break ranging from 80% to 120%, preferably ranging from 90% to 110%.

The physicochemical characteristics of the thermoplastic retaining material advantageously make it possible to separate one or more insulated electrical conductors of the twisted bunch at any point along the assembly, doing so manually, without the aid of a specific tool.

Particularly preferably, all the insulated electrical conductors lie on the external periphery of the twisted bunch. The twisted bunch formed by the insulated electrical conductors according to the invention thus has no insulated electrical conductor at she center thereof. Thus, a portion of the insulating material of each insulated electrical conductor of the twisted bunch remains visually identifiable from outside the assembly, preferably the portion of the insulating material of each insulated electrical conductor remains identifiable continuously along the assembly.

When two insulated electrical conductors are in contact, they form a groove, or empty space, at the external surface of the twisted bunch. This will be referred to in the rest of the description as “external groove”.

When the thermoplastic retaining material is placed continuously along the assembly, preferably in the external groove or grooves, the mechanical retention of the assembly is uniform over the entire length of the assembly.

The thermoplastic retaining material comprises at least one polyvinyl chloride and/or at least one polyolefin, especially one satisfying the physicochemical characteristics i) and ii), and may of course be a blend of polyvinyl chloride and/or polyolefins.

The thermoplastic retaining material may furthermore comprise at least one elastomer in an amount such that the thermoplastic retaining material can maintain its thermoplastic properties and in particular satisfy the physicochemical characteristics i) and ii).

To further improve the physicochemical affinities between the thermoplastic retaining material and the insulating material of the insulated electrical conductors, the thermoplastic retaining material is identical to the insulating material of the insulated electrical conductors.

In one particular embodiment, the thermoplastic retaining material further includes at least one additive chosen from slip agents, anti-rodent agents and tracers of physicochemical phenomena, or one of their blends.

To give examples, the following may be mentioned: as slip agent, waxes, oils or dry lubricants; as anti-rodent agent, aromatic ketones; and as tracer of physicochemical phenomena, cellulosics, acrylics or ketone esters.

The number of insulated electrical conductors of the assembly according to the invention may preferably range from 2 to 6.

According to another feature, each electrical conductor (when not insulated) has a cross section ranging from 0.25 mm² to 6 mm².

Another subject of the invention is a process for manufacturing the assembly as defined above, the process comprising the steps consisting in:

A) twisting together the insulated electrical conductors arranged parallel to one another so as to form a twisted bunch; and

B) placing the thermoplastic retaining material so as to connect together all the insulated electrical conductors of the twisted bunch obtained in step A) by means of the thermoplastic retaining material so that each insulated electrical conductor of the twisted bunch is connected to at least one insulated electrical conductor adjacent thereto, and so that a portion of the insulating material of at least one insulated electrical conductor of the twisted bunch remains visually identifiable from outside the assembly.

Steps A) and B) may be carried out in tandem, that is to say continuously one after the other on the same production line, or else discontinuously, i.e. in batch mode.

In a preferred embodiment, step B) is carried out using an extruder, by extruding and depositing, preferably continuously along the assembly, the thermoplastic retaining material around the twisted bunch in the external grooves of said twisted bunch. Typically, the extrusion is a “stuffing” extrusion. The internal structure of the die at the exit of the extruder prevents the thermoplastic retaining material from completely covering the entire twisted bunch so at to leave visible a portion of the insulating material of the insulated electrical conductor or wires, preferably all the constituent insulated electrical conductors of the assembly. This type of manufacturing process is well known to those skilled in the art.

Other features and advantages of the present invention will become apparent in the light of the following examples with reference to the annotated figures, said examples and figures being given by way of illustration but are in no way limiting.

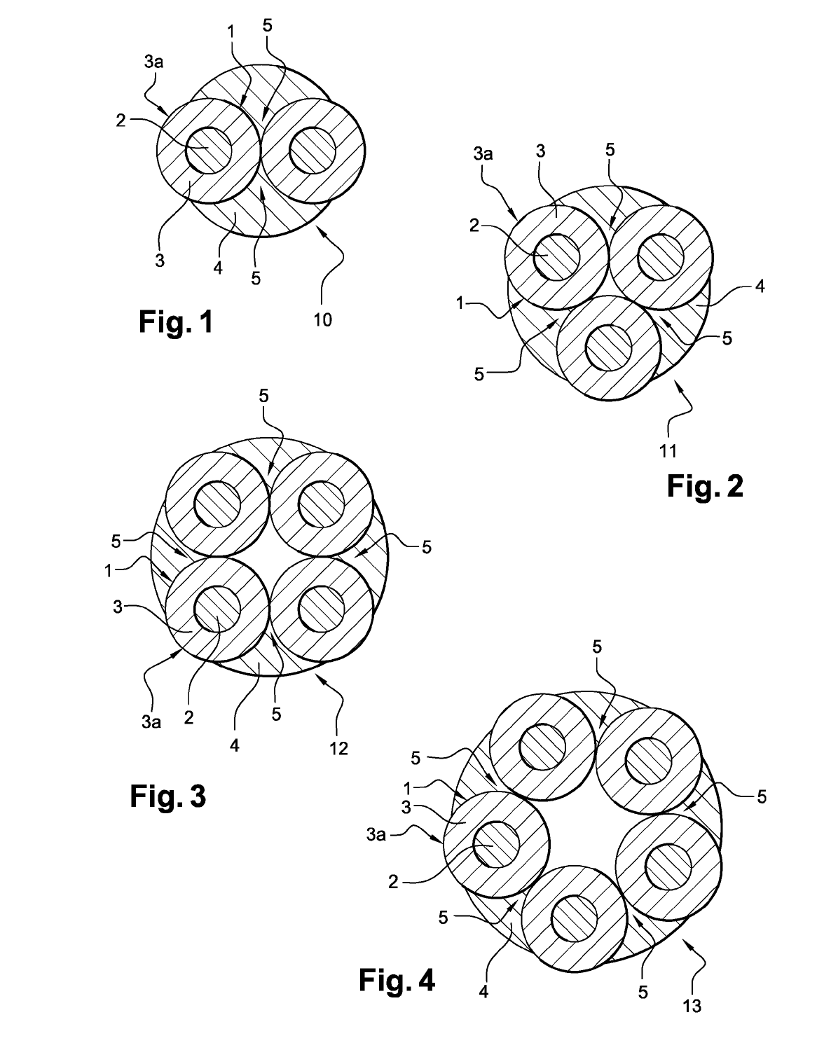

FIGS. 1 to 4 show schematically cross-sectional structures of various assemblies of insulated electrical conductors or “insulated wires” in accordance with the present invention.

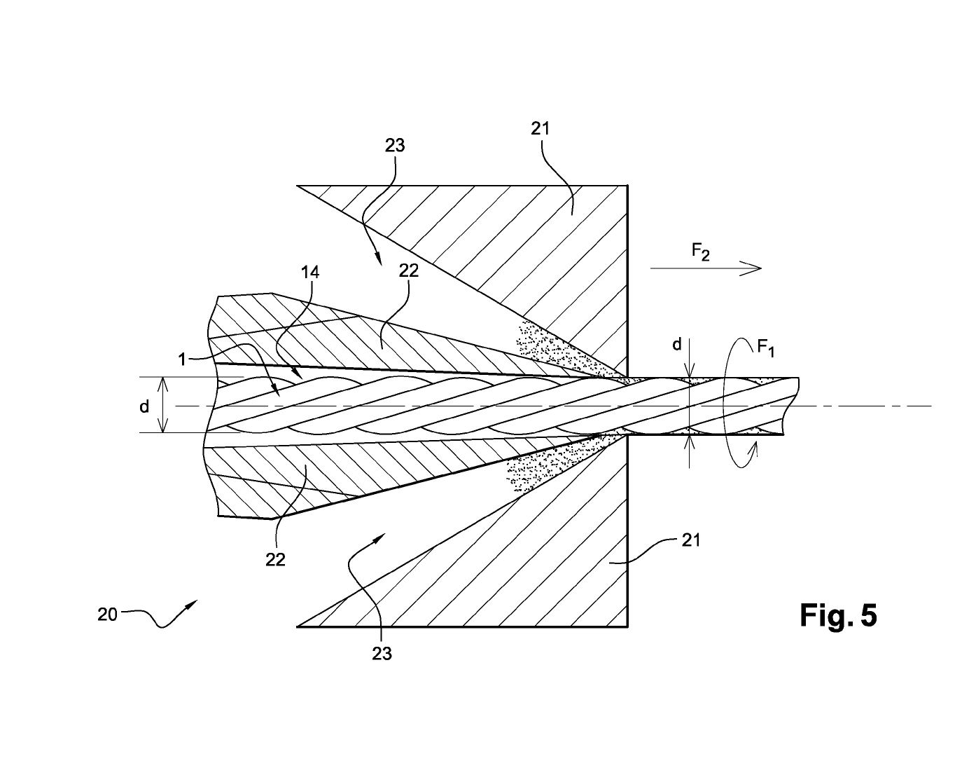

FIG. 5 shows schematically, in longitudinal section, the extrusion head of an extruder during the step of depositing the thermoplastic retaining material on a twisted bunch in accordance with the invention.

For reasons of clarity, identical elements have been denoted by identical references. Likewise, only the essential elements for understanding the invention have been shown schematically, but have not been drawn to scale.

FIG. 1 illustrates an assembly 10 of two insulated wires 1, each insulated wire 1 comprising a central conducting core 2 surrounded by an insulating material 3. These two insulated wires are brought into contact with each other and twisted together. A thermoplastic retaining material 4 is extruded and deposited continuously in the external grooves 5 formed between the two insulated wires so as to bond them together. Said thermoplastic retaining material fills the external grooves 5 so that the outside diameter of the circular cross section in which the thermoplastic retaining material is inscribed is less than the outside diameter of the circular cross section in which the twisted bunch is inscribed. In this way, the thermoplastic retaining material does not completely cover the twisted bunch, rather it leaves visible a portion 3a of the insulating material of each insulated wire 1 along the assembly 10.

FIGS. 2, 3 and 4 show other examples of assembly 11, 12, 13 comprising three, four and five twisted insulated wires 1 respectively. A thermoplastic retaining material 4 is extruded and deposited continuously in the external grooves 5 formed between each insulated wire so as to bond them together. Said thermoplastic retaining material fills the external grooves so that the outside diameter of the circular cross section in which the thermoplastic retaining material is inscribed is less than the outside diameter of the circular cross section in which the twisted bunch is inscribed. In this way, the thermoplastic retaining material does not completely cover the twisted bunch, rather it leaves visible the portion 3a of the insulating material of each insulated wire 1 along the assembly 11, 12, 13.

As shown in FIGS. 1 to 4, the assembly does not have any wire at the center of the twisted bunch.

FIG. 5 shows schematically the extrusion head 20 of an extruder in longitudinal section during the step of depositing the thermoplastic retaining material on a twisted bunch 14 of insulated electrical, conductors 1 in accordance with the invention. This extrusion head 20 comprises a die 21 with an inside exit diameter d identical to the diameter in which the twisted bunch 14 is inscribed. A guiding mandrel 22, also of inside exit diameter d, is positioned upstream of the die 21. A delivery channel 23 serves to bring a stream of thermoplastic retaining material in the molten state onto the twisted bunch 14, said delivering channel 23 being positioned between the die 21 and the guiding mandrel 22. Furthermore, the twisted bunch 14 rotates on itself as shown by the arrow F1, while progressing in the direction of the arrow F2.

The inside exit diameter d of the die 21 prevents the thermoplastic retaining material from covering all of the twisted bunch and allows the thermoplastic retaining material, to be deposited only in the external grooves of the twisted bunch 14. As regards the guiding mandrel 22, this enables the twisted bunch to be centered so as to guarantee a uniform extruded thickness of the thermoplastic retaining material over the entire length of the twisted bunch and to prevent material (thermoplastic retaining material) from flowing back into the delivery channel 23.

### EXAMPLES

An assembly as shown in FIG. 2 is manufactured by helically twisting three insulated wires each having a conducting core of 1.5 mm² cross section covered by an insulating layer of PVC material with an average thickness of 0.7 mm, said PVC material being sold by the company INEOS Compounds under the reference GGA 100.

Next, a thermoplastic retaining material is extruded and deposited around the twisted bunch in the external grooves of the twisted bunch according to the process as described above and in accordance with the present invention. The thermoplastic retaining material is by nature identical to that of the insulating layers of the insulated wires.

The assembly thus formed makes it possible for each insulated wire constituting the assembly to be clearly identified visually by the operator over the entire length of the assembly.

Characterization of the Material

In the present invention, the density of the thermoplastic retaining material is determined by the Archimedes buoyancy method. This method consists in measuring the weight of the object in air and then in a liquid, such as ethanol.

As regards the force to separate two insulated electrical conductors, it is determined by the method consisting in firstly separating two insulated electrical conductors of the assembly over a 5 cm length. Next, these two separated insulated electrical conductors are held respectively between the two laws of a tensile testing machine. The tensile testing machine then records the measurements relating to the force to separate these two insulated electrical conductors of the assembly beyond the 5 cm of separation.

The elongation at break of the thermoplastic retaining material is determined by the method defined according to the EN 60811 Standard. This method consists in firstly producing dumbbell-shaped tensile test specimens from the thermoplastic retaining material of the invention. The ends of a test specimen are held respectively between the two jaws of a tensile testing machine. The tensile testing machine then records the measurements relating to the breaking of said test specimen.

To make it easier to separate the bonded wires of the assembly without using a specific tool, it is necessary to have a product P of less than 3 and an elongation at break of less than 120%, the product P being the product of the density of the thermoplastic retaining material in g/cm³ multiplied by the force in MPa to separate two insulated electrical conductors connected by means of the thermoplastic retaining material.

Furthermore, to maintain sufficient mechanical retention during any handling of the assembly, said product P and the elongation at break must be greater than 1.5 and greater than 80% respectively.

Using the three methods detailed above for characterizing the thermoplastic retaining material according to the invention, a person skilled in the art may easily identify materials capable of falling within the scope of the invention and obtain the expected advantages.

The PVC material used in the abovementioned example complies with the present invention. It is characterized by the following physicochemical properties:
density: between 1.05 g/cm³ and 1.20 g/cm³,
resistance to separation: between 1.5 MPa and 2.4 MPa, and
elongation at break: between 90% and 110%.

1. An assembly comprising:
insulated electrical conductors arranged so as to be parallel to one another, each electrical conductor being surrounded by an insulating material; and
a thermoplastic retaining material,
wherein the insulated electrical conductors are twisted together, forming a twisted bundle, and said thermoplastic retaining material is placed so as to connect together all the insulated electrical conductors of the twisted bundle so that each insulated electrical conductor is connected to at least one insulated electrical conductor adjacent thereto, and so that a portion of the insulating material of at least one insulated electrical conductor of the twisted bunch remains visually identifiable from outside the assembly.

2. The assembly as claimed in claim 1, wherein the thermoplastic retaining material is selected from the group of materials having the following physicochemical characteristics:
i) a product P of the density of the thermoplastic retaining material in g/cm³, multiplied by the force in MPa to separate two insulated electrical conductors joined by means of the thermoplastic retaining material, ranging from 1.5 to 3; and
ii) an elongation at break ranging from 80% to 120%, preferably ranging from 90% to 110%.

3. The assembly as claimed in claim 1, wherein the thermoplastic retaining material is placed continuously along the assembly.

4. The assembly as claimed in claim 1, wherein all the insulated electrical conductors lie on the external periphery of the twisted bunch.

5. The assembly as claimed in claim 1, wherein the portion of the insulating material remains identifiable continuously along the assembly.

6. The assembly as claimed in claim 1, wherein the thermoplastic retaining material comprises at least one polyvinyl chloride and/or at least one polyolefin.

7. The assembly as claimed in claim 1, wherein the thermoplastic retaining material is identical to the insulating material of the insulated electrical conductors.

8. The assembly as claimed in claim 1, wherein the thermoplastic retaining material further includes at least one additive selected from the group consisting of slip agents, anti-rodent agents and tracers of physicochemical phenomena.

9. The assembly as claimed in claim 1, wherein said assembly comprises 2 to 6 insulated electrical conductors.

10. The assembly as claimed in claim 1, wherein each electrical conductor has a cross section ranging from 0.25 mm² to 6 mm².

11. A process for manufacturing the assembly as defined in claim 1, said process comprising the steps of:
A) twisting together the insulated electrical conductors arranged parallel to one another so as to form a twisted bunch; and
B) placing the thermoplastic retaining material so as to connect together all the insulated electrical conductors of the twisted bunch obtained in step A) by means of the thermoplastic retaining material so that each insulated electrical conductor of the twisted bunch is connected to at least one insulated electrical conductor adjacent thereto, and so that a portion of the insulating material of at least one insulated electrical conductor of the twisted bunch remains visually identifiable from outside the assembly.
